(19) United States
(12) Patent Application Publication
(10) Pub. No.: US 2021/0291555 A1
(43) Pub. Date: Sep. 23, 2021

(54) METHOD FOR MANUFACTURING THERMAL PRINT HEADS

(71) Applicant: CHIEN HWA COATING TECHNOLOGY INC., HSINCHU CITY (TW)

(72) Inventors: HUNGYI PENG, HSINCHU CITY (TW); YIWEI LIN, HSINCHU CITY (TW); CHUNCHEN CHEN, HSINCHU CITY (TW)

(21) Appl. No.: 17/065,608

(22) Filed: Oct. 8, 2020

(30) Foreign Application Priority Data
Mar. 20, 2020 (TW) 109109327

(51) Int. Cl. B41J 2/335; B41J 2/34

(52) U.S. Cl. CPC B41J 2/3359; B41J 2/3351; B41J 2/34

(57) ABSTRACT

The present invention provides a method for manufacturing thermal print heads. By forming a molybdenum antioxidation layer on the electrode pattern layer, the oxidation or erosion phenomena on the electrode pattern layer (formed by aluminum or aluminum-copper alloy) in the manufacturing process can be prevented, and hence improving the reliability and lifetime of thermal print heads.

### FIELD OF THE INVENTION

The present invention relates generally to a thermal print head, and particularly to a method for manufacturing thermal print heads.

### BACKGROUND OF THE INVENTION

Decalcomania printing technology is originated from the 18th century. In the 1950s, the term “decal” roughly refers to the water transfer printing. In the 1960s, the thermal transfer technology is developed. Nowadays, various transfer printing methods are developed. The subject to be printed includes plane surfaces and stereoscopic curved surfaces with various materials such as paper, plastics, and metals, enabling extensive applications of the technology. To overcome the bottleneck caused by the physical properties and transfer characteristics of different subjects to be print, various transfer forms are developed correspondingly.

Specifically, transfer printing is transferring the graph or text on an intermediate carrier thin film to a subject to be printed using corresponding pressure. According to the types of the pressure source, it can be categorized into thermal, water, air, silk-screen, and low-temperature transfer printing.

Thermal transfer printing refers to printing graph or text to an intermediate carrier such as paper or transfer film using thermal transfer ink. Then, by heating the carrier to a certain temperature (normally 180˜230□) in a few minutes using corresponding transfer equipment, the graph or text on the carrier can be transferred to a different material.

In general, the printers adopting thermal transfer principle mainly use a thermal print head (TPH) module to heat color ribbons. The die on color ribbons is vaporized before being transferred to the carrier such as paper or plastics. In addition, continuous color scales can be formed according heating length or temperature. The TPH module is formed by a ceramic substrate, a printed circuit board, a packaging glue layer, integrated circuits, and wires.

Unfortunately, while manufacturing thermal print heads, since aluminum/aluminum-copper alloy (Al/AlCu) is usually adopted as conductive layers, the problems of oxidation and erosion can occur. Thereby, the reliability and lifetime of thermal print heads will be reduced.

Accordingly, how to reduce the oxidation and erosion phenomena in conductive layers and thus extending the lifetime of thermal print heads in the manufacturing process has become the problem to be solved in this field.

### SUMMARY

An objective of the present invention is to provide a method for manufacturing thermal print heads. By forming an antioxidation layer (using molybdenum) between the electrode pattern layer and the passivation layer, oxidation or erosion of the electrode pattern layer (using Al/AlCu) in the manufacturing process can be prevented. Thereby, the reliability and lifetime of thermal print heads will be reduced.

To achieve the achieve the above objective and efficacy, the present invention discloses a method for manufacturing thermal print heads, which comprises steps of: preparing a silicon substrate; disposing a glaze layer on the silicon substrate; disposing a thermal resistance layer on the glaze layer; disposing an electrode pattern layer on the thermal resistance layer; disposing an antioxidation layer on the electrode pattern layer, and the antioxidation layer being molybdenum; disposing a passivation layer on the antioxidation layer; and disposing a control circuit module, connected electrically to the electrode pattern layer.

According to an embodiment of the present invention, the silicon substrate is a single-crystal silicon substrate or a polysilicon substrate.

According to an embodiment of the present invention, the step of disposing a glaze layer on the silicon substrate further comprises steps of forming a main glaze layer on one side of the silicon substrate; and forming a plurality of projective glaze strips spaced side-by-side on the side of the main glaze layer not facing the silicon substrate.

According to an embodiment of the present invention, the step of disposing a thermal resistance layer on the glaze layer further comprises a step of disposing the thermal resistance layer on the plurality projective glaze strips and forming a plurality of swelling shapes corresponding to the plurality of projective glaze strips.

According to an embodiment of the present invention, the step of disposing an electrode pattern layer on the thermal resistance layer further comprises steps of forming a conductive metal layer on the side of the thermal resistance layer not facing the glaze layer; and etching the conductive metal layer above the plurality of projective glaze strips to form a etch opening exposing the corresponding plurality of swelling shapes of the plurality of projective glaze strips, respectively.

According to an embodiment of the present invention, the step of disposing a passivation layer on the antioxidation layer further comprises a step of partially etching the passivation layer and the antioxidation layer to form an opening for exposing the electrode pattern layer.

According to an embodiment of the present invention, the step of disposing a control circuit module connected electrically to the electrode pattern layer further comprises a step of connecting electrically the control circuit module to the electrode pattern layer through the opening.

### BRIEF DESCRIPTION OF THE DRAWINGS

FIG. 1 shows a flowchart according to an embodiment of the present invention;

FIGS. 2A to 2F shows operational schematic diagrams according to an embodiment of the present invention; and

FIG. 3 shows a structural schematic diagram according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

Considering the oxidation or erosion problem of the electrode pattern layer (using Al or AlCu) during the manufacturing process, the present invention provides a method for manufacturing thermal print heads for solving the problem according to the prior art.

In the following, the properties and the accompanying structure of the method for manufacturing thermal print heads according to the present invention will be further described.

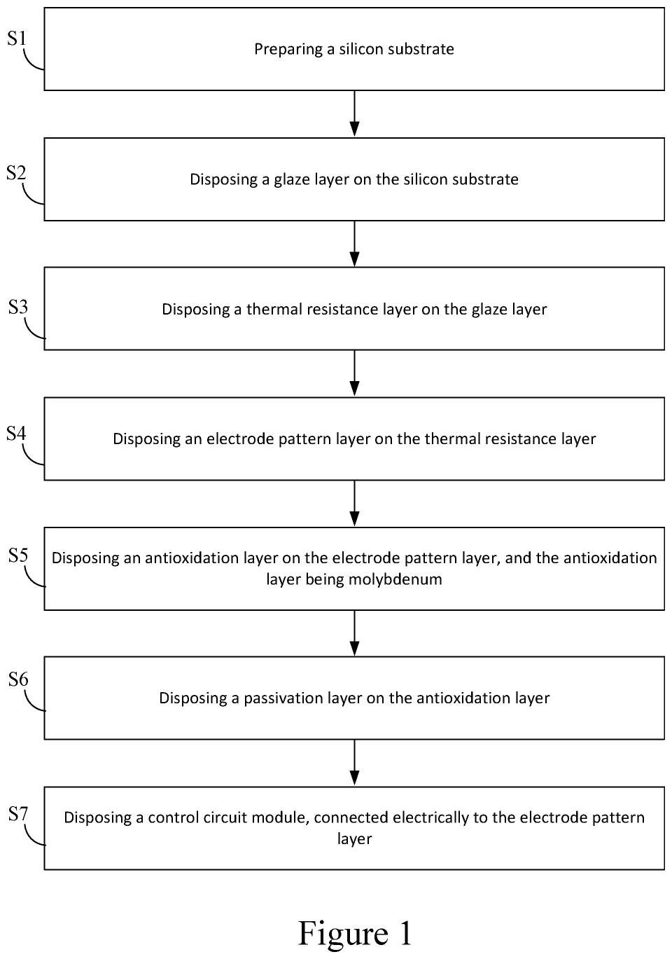

Please refer to FIG. 1, which shows a flowchart according to an embodiment of the present invention. As shown in the figure, the method for manufacturing thermal print heads according to the present invention comprises steps of:
S1: Preparing a silicon substrate;
S2: Disposing a glaze layer on the silicon substrate;
S3: Disposing a thermal resistance layer on the glaze layer;
S4: Disposing an electrode pattern layer on the thermal resistance layer;
S5: Disposing an antioxidation layer on the electrode pattern layer, and the antioxidation layer being molybdenum;
S6: Disposing a passivation layer on the antioxidation layer; and
S7: Disposing a control circuit module, connected electrically to the electrode pattern layer.

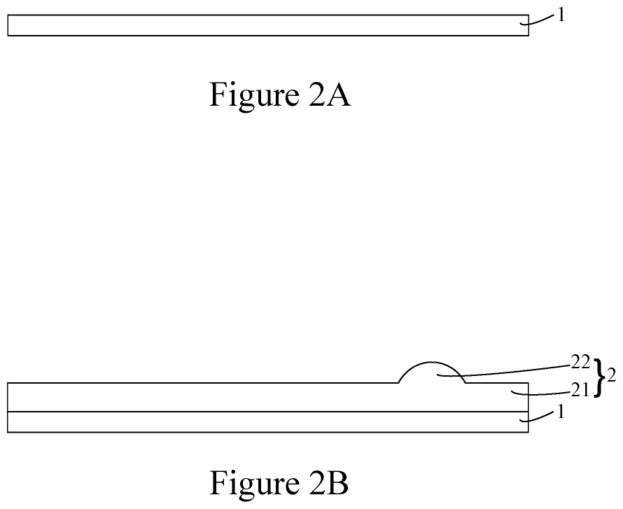

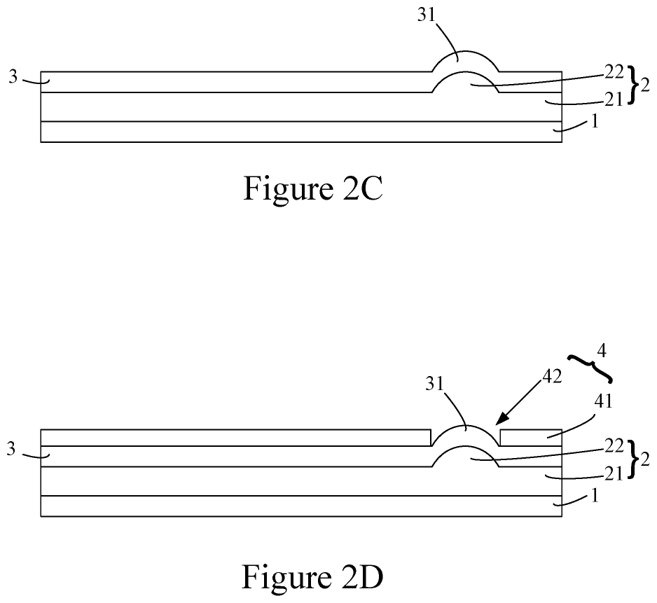

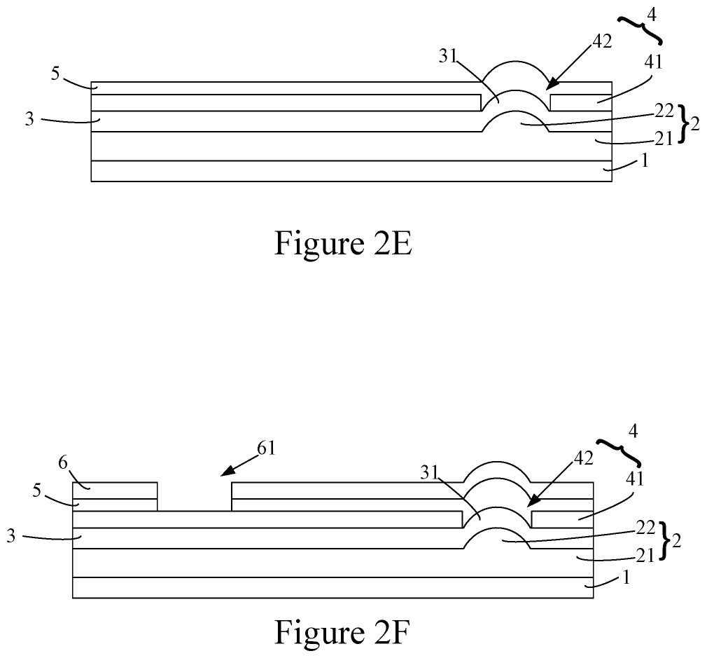

As shown in the step S1 and FIG. 2A, prepare a silicon substrate 1, which is a single-crystal silicon substrate or a polysilicon substrate. In addition, the silicon substrate 1 can be formed by a wet or a dry process.

Next, as shown in the step S2 and FIG. 2B (which shows an operational schematic diagram according to an embodiment of the present invention), dispose a glaze layer 2 on the silicon substrate 1. Besides, the step S2 further comprises steps of:
S21: Forming a main glaze layer on one side of the silicon substrate; and
S22: Forming projective glaze strips spaced side-by-side on the side of the main glaze layer not facing the silicon substrate.

As shown in the step S21, by adopting screen printing, a glaze slurry layer, which will form a main glaze layer 21), is coated uniformly on one side of the silicon substrate 1. The glaze slurry is sintered and solidified at high temperatures (1000˜1200□). Thereby, the main glaze layer 21 can reserve heat and keeping it from easy dissipation. Then, as shown in the step S22, by adopting screen printing, a plurality of projective glaze strips 22 are coated on the side of the main glaze layer 21 not facing the silicon substrate 1. The plurality of projective glaze strips are spaced side-by-side, linear, and continuous on the main glaze layer 21.

Next, as shown in the step S3 and FIG. 2C (which shows an operational schematic diagram according to an embodiment of the present invention), dispose a thermal resistance layer 3 on the glaze layer 2. Besides, the step S3 further comprises a step of:
S31: Disposing the thermal resistance layer on the projective glaze strips and forming swelling shapes corresponding to the projective glaze strips.

As shown in the step S31, dispose the thermal resistance layer 3 on the plurality of projective glaze strips 22 using a sputtering process and forming a plurality of swelling shapes 31 corresponding to and on the plurality of projective glaze strips 22.

Next, as shown in the step S4 and FIG. 2D (which shows an operational schematic diagram according to an embodiment of the present invention), dispose an electrode pattern layer 4 on the thermal resistance layer 3 using a sputtering process. Besides, the step S4 further comprises steps of:
S41: Forming a conductive metal layer on the side of the thermal resistance layer not facing the glaze layer; and
S42: Etching the conductive metal layer above the projective glaze strips to form a etch opening exposing the corresponding swelling shapes of the projective glaze strips, respectively.

As shown in the step S41, form a conductive metal layer 41, such as aluminum, copper, silver, or gold, on the side of the thermal resistance layer 3 not facing the glaze layer 2. Next, as shown in the step S42, after forming the conductive metal layer 41, etch the conductive metal layer 41 above the plurality of projective glaze strips 22 and the plurality of swelling shapes 31 to form a etch opening 42 exposing the corresponding plurality of swelling shapes 31 of the plurality of projective glaze strips 22, respectively.

Then, as shown in the step S5 and FIG. 2E (which shows an operational schematic diagram according to an embodiment of the present invention), dispose an antioxidation layer 5 on the electrode pattern layer 4 using a sputtering process. The antioxidation layer 5 is molybdenum, which can prevent the electrode pattern layer 4 from being oxidized or eroded. Thereby, the lifetime of thermal print heads can be extended.

Moreover, as shown in the step S6 and FIG. 2F (which shows an operational schematic diagram according to an embodiment of the present invention), dispose a passivation layer 6 on the antioxidation layer 5 using chemical vapor deposition. Besides, the step S6 further comprises a step of:
S61: Partially etching the passivation layer and the antioxidation layer to form an opening for exposing the electrode pattern layer.

As shown in the step S61, dispose the passivation layer 6 and the antioxidation layer 5 on the electrode pattern layer 4. A portion of the passivation layer 6 and a portion of the antioxidation layer 5 cover the electrode pattern layer 4. The rest portion of the passivation layer 6 and the rest portion of the antioxidation layer 5 appear in the etch opening 42 for covering the plurality of swelling shapes 31 of the thermal resistance layer 3 and connecting closely to the thermal resistance layer 3. Next, after forming the passivation layer 6, partially etch the passivation layer 6 and the antioxidation layer 5 to form an opening 61 for exposing the electrode pattern layer 4.

Finally, as shown in the step S7, dispose a control circuit module 7 connected electrically to the electrode pattern layer 4 through the opening 61. The control circuit module 7 is preferably selected from the group consisting of a chip on film (COF), an operating chip, and a circuit board (a printed circuit board or a flexible circuit board).

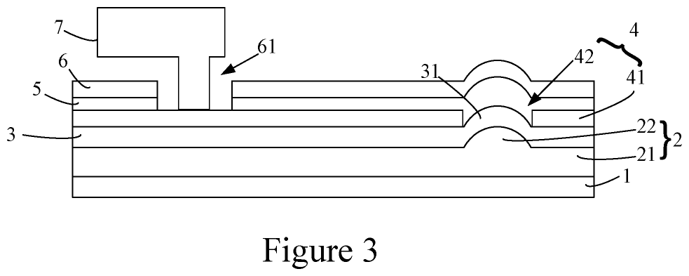

Furthermore, FIG. 3 shows a structural schematic diagram according to an embodiment of the present invention. As shown in the figure, the thermal print head is formed by growing upwards from the silicon substrate 1, comprising sequentially the silicon substrate 1, the glaze layer 2, the thermal resistance layer 3, the electrode pattern layer 4, the antioxidation layer 5, and the passivation layer 6, and then connecting electrically to the control circuit module 7.

By adopting screen printing, a glaze slurry layer, which will form the main glaze layer 21), is coated uniformly on one side of the silicon substrate 1. The glaze slurry is sintered and solidified at high temperatures (1000˜1200□). Then, by adopting screen printing, the plurality of projective glaze strips 22 are coated on the side of the main glaze layer 21 not facing the silicon substrate 1. Next, dispose the thermal resistance layer 3 on the main glaze layer 21 and the plurality projective glaze strips 22 and forming the plurality of swelling shapes 31 corresponding to the plurality of projective glaze strips 22.

In addition, while disposing the electrode pattern layer 4, form the conductive metal layer 41, such as aluminum, copper, silver, or gold, on the side of the thermal resistance layer 3 not facing the glaze layer 2. Then, after forming the conductive metal layer 41, etch the conductive metal layer 41 above the plurality of projective glaze strips 22 and the plurality of swelling shapes 31 to form the etch opening 42 exposing the corresponding plurality of swelling shapes 31 of the plurality of projective glaze strips 22, respectively.

Next, different from the manufacturing method according to the prior art, the present invention first dispose the antioxidation layer 5 using sputtering before disposing the passivation layer 6. By using the molybdenum in the antioxidation layer 5, the oxidation or erosion phenomena of the electrode pattern 4 in the manufacturing process can be prevented. Thereby, the reliability of the lifetime of thermal print heads can be improved. After disposing the antioxidation layer 5, dispose the passivation layer 6 on the antioxidation layer 5. A portion of the passivation layer 6 and a portion of the antioxidation layer 5 cover the electrode pattern layer 4. The rest portion of the passivation layer 6 and the rest portion of the antioxidation layer 5 appear in the etch opening 42 for covering the plurality of swelling shapes 31 of the thermal resistance layer 3 and connecting closely to the thermal resistance layer 3. Next, after forming the passivation layer 6, partially etch the passivation layer 6 and the antioxidation layer 5 to form the opening 61 for exposing the electrode pattern layer 4.

Finally, dispose the control circuit module 7, which is connected electrically to the electrode pattern layer 4 through the opening 61. Besides, the silicone substrate 1 include a single-crystal silicon substrate or a polysilicon substrate. The spacing between the plurality of projective glaze strips 22 is, but not limited to, 0.5 to 2 centimeters.

What is claimed is:

1. A method for manufacturing thermal print heads, comprising steps of:
preparing a silicon substrate;
disposing a glaze layer on said silicon substrate;
disposing a thermal resistance layer on said glaze layer;
disposing an electrode pattern layer on said thermal resistance layer;
disposing an antioxidation layer on said electrode pattern layer, and said antioxidation layer being molybdenum;
disposing a passivation layer on said antioxidation layer; and
disposing a control circuit module, connected electrically to said electrode pattern layer.

2. The method for manufacturing thermal print heads of claim 1, wherein said silicon substrate is a single-crystal silicon substrate or a polysilicon substrate.

3. The method for manufacturing thermal print heads of claim 1, wherein said step of disposing a glaze layer on said silicon substrate further comprises steps of:
forming a main glaze layer on one side of said silicon substrate; and
forming a plurality of projective glaze strips spaced side-by-side on the side of said main glaze layer not facing said silicon substrate.

4. The method for manufacturing thermal print heads of claim 3, wherein said step of disposing a thermal resistance layer on the glaze layer further comprises a step of disposing said thermal resistance layer on said plurality projective glaze strips and forming a plurality of swelling shapes corresponding to said plurality of projective glaze strips.

5. The method for manufacturing thermal print heads of claim 4, wherein said step of disposing an electrode pattern layer on the thermal resistance layer further comprises steps of:
forming a conductive metal layer on the side of said thermal resistance layer not facing said glaze layer; and
etching said conductive metal layer above said plurality of projective glaze strips to form a etch opening exposing said corresponding plurality of swelling shapes of said plurality of projective glaze strips, respectively.

6. The method for manufacturing thermal print heads of claim 1, wherein said step of disposing a passivation layer on said antioxidation layer further comprises a step of partially etching said passivation layer and said antioxidation layer to form an opening for exposing said electrode pattern layer.

7. The method for manufacturing thermal print heads of claim 6, wherein said step of disposing a control circuit module connected electrically to said electrode pattern layer further comprises a step of connecting electrically said control circuit module to said electrode pattern layer through said opening.
